(19) United States
(12) Patent Application Publication
(10) Pub. No.: US 2013/0145062 A1
(43) Pub. Date: Jun. 6, 2013

(54) UNIVERSAL SERIAL BUS PRE-DETERMINING CIRCUIT

(71) Applicants: CHUN-TSAI CHEN, NEW TAIPEI CITY (TW); CHING-FENG HSIEH, TAIPEI CITY (TW)

(72) Inventors: CHUN-TSAI CHEN, NEW TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/343,768

(22) Filed: Jan. 5, 2012

(30) Foreign Application Priority Data
Dec. 2, 2011 (TW) 100144353

(51) Int. Cl. G06F 13/00

(52) U.S. Cl. 710/104

(57) ABSTRACT

A universal serial bus pre-determining circuit for determining whether a universal serial bus is connected to a host or a device includes an input unit, a detection unit, a processing unit, and a switch unit. The input unit is connected to the host or the device. Once the input unit is connected to the host, the detection unit will enable the host, allowing the host to generate and send a synchronous signal to the input unit. Once the input unit is connected to the device, no synchronous signal will be generated. The processing unit determines accurately whether the universal serial bus is connected to the host or the device by judging the synchronous signal.

### CROSS-REFERENCE TO RELATED APPLICATION

This non-provisional application claims priority under 35 U.S.C. §119(a) on Patent Application No(s).100144353 filed in Taiwan, R.O.C. on Dec. 2, 2011, the entire contents of which are hereby incorporated by reference.

### FIELD OF TECHNOLOGY

The present invention relates to determining circuits, and more particularly, to a universal serial bus pre-determining circuit.

### BACKGROUND

According to related prior art, a universal serial bus (USB) operates either in a host-connected mode or in a device-connected mode, depending on the purpose of the USB. In the host-connected mode, the purpose of the USB is to transfer data. In the device-connected mode, the USB enables transmission that does not involve any data, such as power transmission.

According to related prior art, the USB intended for operation in the host-connected mode and the USB intended for operation in the device-connected mode are distinguished from each other by their respective special pins or connectors. The aforesaid means of distinction, however, is not applicable to standardized USBs. As a result, the host-connected mode and the device-connected mode can be distinguished from each other only if different USBs are manufactured at the cost of increased manufacturing costs.

To solve the aforesaid problem, the prior art teaches including a 1.5KΩ ground resistor in a USB device for discerning the host-connected mode and the device-connected mode. However, other devices are likely to be equipped with a 1.5KΩ ground resistor adapted to prevent interference. Hence, in this regard, the compatibility issue surfaces inevitably.

Although the aforesaid ground resistors have their respective functions and thereby serve their respective purposes, their coexistence in a device is likely to cause misjudgment of the host-connected mode and the device-connected mode.

In view of the aforesaid drawbacks of the prior art, the present invention provides a universal serial bus pre-determining circuit capable of overcoming the aforesaid drawbacks of the prior art.

### SUMMARY

It is an objective of the present invention to provide a universal serial bus pre-determining circuit for determining accurately whether a universal serial bus (USB) is connected to a host or a device.

In order to achieve the above and other objectives, the present invention provides a universal serial bus pre-determining circuit for determining whether a universal serial bus (USB) is connected to a host or a device. The universal serial bus pre-determining circuit comprises an input unit, a detection unit, and a processing unit. The input unit is connected to one of the host and the device. The detection unit is connected to the input unit for generating a detecting signal DS based on one of the host and the device and enabling, when connected to the host, the host to generate and send a synchronous signal to the input unit. The processing unit is connected to the input unit and the detection unit for selectively receiving the synchronous signal and generating a control signal based on the detecting signal DS and severing the connection of the input unit and the detection unit to determine whether the input unit is connected to the host or the device based on the control signal.

Unlike the prior art, the present invention provides a universal serial bus pre-determining circuit connected between the USB and the host as well as the device such that, after the USB has been connected to the host or the device, the universal serial bus pre-determining circuit determines accurately whether the USB is connected to the host or the device. Hence, the universal serial bus pre-determining circuit of the present invention precludes a drawback of the prior art, that is, misjudgment of the host-connected mode and the device-connected mode results in erroneous operation.

### BRIEF DESCRIPTION

Objectives, features, and advantages of the present invention are hereunder illustrated with specific embodiments in conjunction with the accompanying drawings, in which:

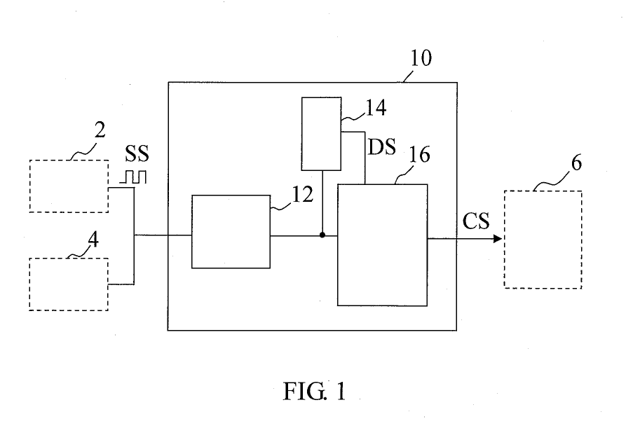

FIG. 1 is a schematic block diagram of a universal serial bus pre-determining circuit according to the first embodiment of the present invention;

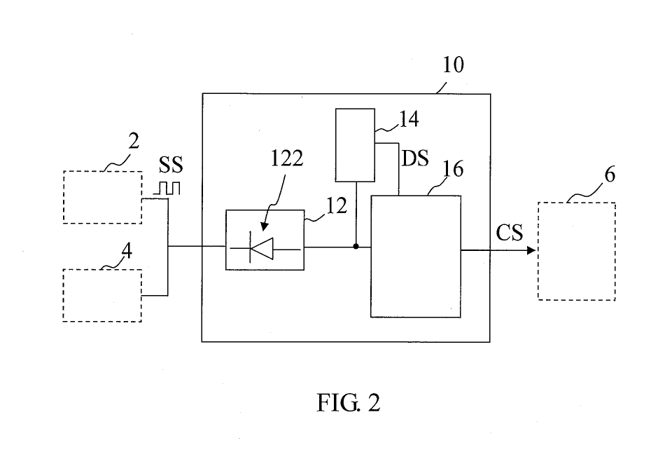

FIG. 2 is a schematic block diagram of an input unit in FIG. 1 according to the first embodiment of the present invention;

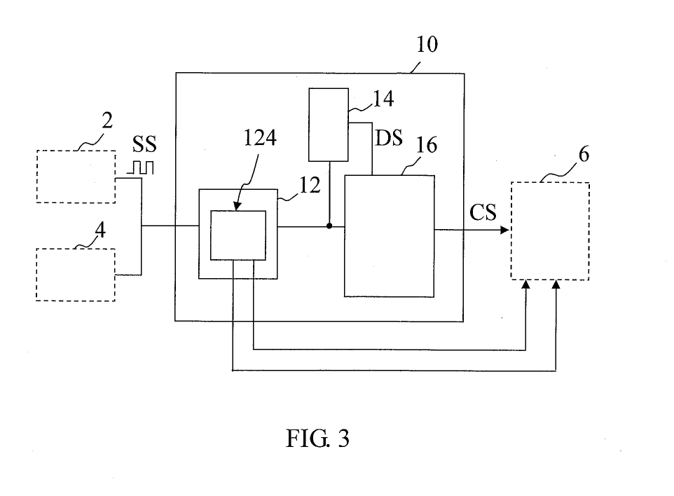

FIG. 3 is a schematic block diagram of the input unit in FIG. 1 according to the second embodiment of the present invention;

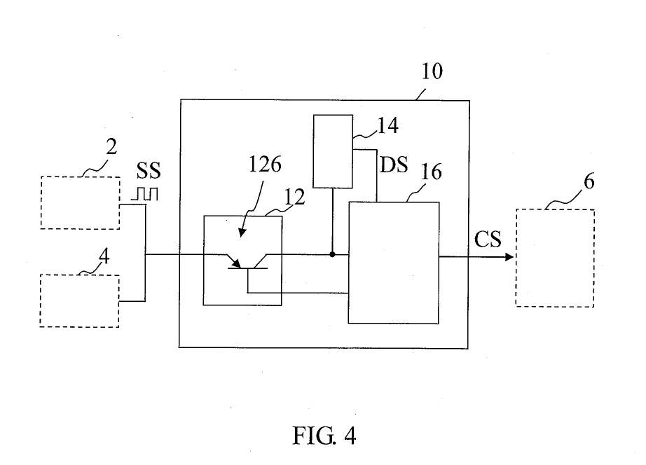

FIG. 4 is a schematic block diagram of the input unit in FIG. 1 according to the third embodiment of the present invention; and

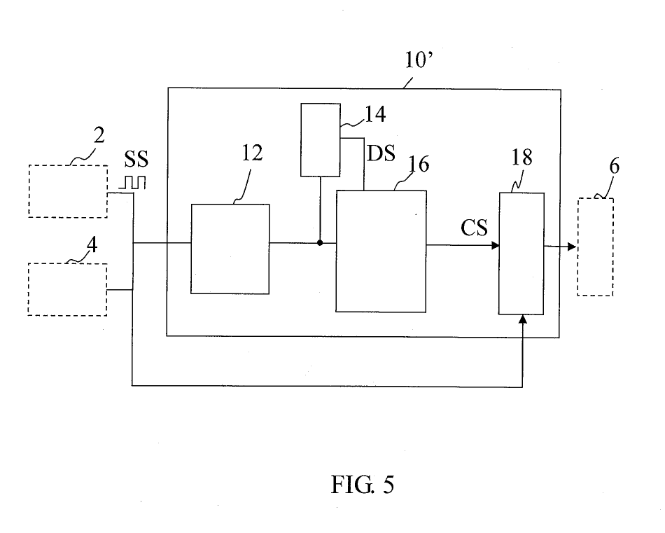

FIG. 5 is a schematic block diagram of a universal serial bus pre-determining circuit according to the second embodiment of the present invention.

### DETAILED DESCRIPTION

Referring to FIG. 1, there is shown a schematic block diagram of a universal serial bus pre-determining circuit 10 according to the first embodiment of the present invention. As shown in FIG. 1, the universal serial bus pre-determining circuit 10 determines whether a universal serial bus (USB) 6 is connected to a host 2 or a device 4. For example, the host 2 is a notebook computer having a USB port, a desktop computer having a USB port, a tablet computer having a USB port, or a smartphone having a USB port. For example, the device 4 is a charger having a USB port.

The universal serial bus pre-determining circuit 10 comprises an input unit 12, a detection unit 14, and a processing unit 16. The input unit 12 is connected to the host 2 or the device 4. For example, the input unit 12 is a diode, a USB switch, or a transistor electronic switch, and it is connected in different manners shown in FIG. 2, FIG. 3, and FIG. 4.

For example, in FIG. 2, the input unit 12 is exemplified by a diode 122, wherein the negative terminal of the diode 122 is connected to the host 2 and/or the device 4, whereas the positive terminal of the diode 122 is connected to the detection unit 14 and the processing unit 16.

Referring to FIG. 3, the input unit 12 is exemplified by a USB switch 124, and the USB switch 124 is controlled by the processing unit 16 to switch the connection of the host 2 to the detection unit 14, the processing unit 16, or other circuits.

Referring to FIG. 4, the input unit 12 is exemplified by a transistor 126, and the base of the transistor 126 is controlled by the processing unit 16 (for example, by the gate of a field-effect transistor) to perform selective insulation of the detection unit 14 and the processing unit 16 from each other.

Referring to FIG. 1, the detection unit 14 is connected to the input unit 12. The detection unit 14 generates a detecting signal DS based on the host 2 or the device 4. In an embodiment, upon connection of the detection unit 14 and the host 2, the detection unit 14 enables the host 2 and causes the host 2 to generate a synchronous signal SS. For example, the detection unit 14 is a pull-up resistor, and the pull-up resistance level equals 1.5 KΩ. That is to say, upon connection of the universal serial bus pre-determining circuit 10 and the host 2, the host 2 detects, through the input unit 12, whether the detection unit 14 is present. The host 2 takes the initiative in generating the synchronous signal SS as soon as the host 2 determines that the detection unit 14 is present. The synchronous signal SS comprises bits having a duty cycle. In general, the host 2 generates the synchronous signal SS of more than 60 bits. The detecting signal DS drives the processing unit 16 to perform related calculation, for example, calculating the amount of the bits in the synchronous signal SS or the duration of the synchronous signal SS.

The processing unit 16 determines that the host 2 is connected to the input unit 12 as soon as the processing unit 16 receives the synchronous signal SS of a predetermined quantity. The processing unit 16 will determine that the device 4 is connected to the input unit 12, if the processing unit 16 does not receive the synchronous signal SS of the predetermined quantity or the synchronous signal SS is absent. In an embodiment, the predetermined quantity of the synchronous signal SS is at least 10 bits.

If the universal serial bus pre-determining circuit 10 is connected to the device 4, the device 4 will not take the initiative in generating any signal like the synchronous signal SS, and thus the detection unit 14 will not generate the detecting signal DS.

The processing unit 16 is connected to the input unit 12 and the detection unit 14. The processing unit 16 is a microprocessing unit or a complex programmable logic device. The processing unit 16 processes the synchronous signal SS based on the detecting signal DS. For example, after receiving the detecting signal DS, the processing unit 16 starts to count the synchronous signal SS or determines in a period of time whether the synchronous signal SS is continuously generated. The processing unit 16 generates a control signal CS based on the aforesaid means of processing. For example, the control signal CS indicates that the USB 6 is connected to the host 2 instead of the device 4. Upon determination that the input unit 12 is connected to the host 2, the processing unit 16 severs its connection with the detection unit 14.

In an embodiment, the processing unit 16 severs its connection with the detection unit 14 directly as soon as the processing unit 16 determines that it has not received the detecting signal DS. In another embodiment, the processing unit 16 waits a predetermined period of time before severing its connection with the detection unit 14.

After determining whether the universal serial bus pre-determining circuit 10 is connected to the host 2 or the device 4, the universal serial bus pre-determining circuit 10 outputs the control signal CS for indicating a connection mode, regardless of whether the universal serial bus pre-determining circuit 10 is connected to the host 2 or the device 4.

Referring to FIG. 5, there is shown a schematic block diagram of a universal serial bus pre-determining circuit according to the second embodiment of the present invention. As shown in FIG. 5, in addition to the input unit 12, the detection unit 14, and the processing unit 16, a universal serial bus pre-determining circuit 10′ comprises a switch unit 18. The switch unit 18 is connected to the processing unit 16. The switch unit 18 switches connection of the USB 6 to the host 2 or the device 4, and controls the mode of connecting the USB 6 to the host 2 or the device 4 based on the control signal CS. In an embodiment, the switch unit 18 is a USB switch for controlling subsequent connection to another USB.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A universal serial bus pre-determining circuit for determining whether a universal serial bus (USB) is connected to a host or a device, the universal serial bus pre-determining circuit comprising:
an input unit connected to one of the host and the device;
a detection unit connected to the input unit for generating a detecting signal DS based on one of the host and the device and enabling, when connected to the host, the host to generate and send a synchronous signal to the input unit; and
a processing unit connected to the input unit and the detection unit for selectively receiving the synchronous signal and generating a control signal based on the detecting signal DS and severing the connection of the input unit and the detection unit to determine whether the input unit is connected to the host or the device based on the control signal.

2. The universal serial bus pre-determining circuit of claim 1, wherein the processing unit determines whether the input unit is connected to the host or the device based on the synchronous signal received within a period of time.

3. The universal serial bus pre-determining circuit of claim 2, wherein the processing unit determines that the host is connected to the USB as soon as the processing unit receives the synchronous signal of a predetermined quantity.

4. The universal serial bus pre-determining circuit of claim 2, wherein the processing unit will determine that the device is connected to the USB, if the processing unit does not receive the synchronous signal of a predetermined quantity or the synchronous signal is absent.

5. The universal serial bus pre-determining circuit of claim 3, wherein the predetermined quantity of the synchronous signal is at least 10 bits having a duty cycle.

6. The universal serial bus pre-determining circuit of claim 1, wherein the detection unit is a pull-up resistor.

7. The universal serial bus pre-determining circuit of claim 1, wherein the input unit is a diode, a USB switch, or a transistor electronic switch.

8. The universal serial bus pre-determining circuit of claim 7, wherein the diode has a negative terminal connected to the host or the device and has a positive terminal connected to the detection unit and the processing unit.

9. The universal serial bus pre-determining circuit of claim 7, wherein the transistor electronic switch is connected to the processing unit for controlling connection of the input unit and the processing unit.

10. The universal serial bus pre-determining circuit of claim 1, further comprising a switch unit connected to the processing unit and controlling connection of the USB to the host or the device based on the control signal.
